(19) United States
(12) Patent Application Publication
(10) Pub. No.: US 2005/0028960 A1
(43) Pub. Date: Feb. 10, 2005

(54) Chill tube

(76) Inventors: Roland Hauri, Wettswil (CH); Raimund Eichholz-Boldt, Osnabruck (DE); Dietmar Kolbeck, Steinfeld (DE); Gerhard Hugenschutt, Belm (DE)

Correspondence Address: KENYON & KENYON, ONE BROADWAY, NEW YORK, NY, 10004, US

(21) Appl. No.: 10/931,766

(22) Filed: Sep. 1, 2004

Related U.S. Application Data
(63) Continuation of application No. 10/342,559, filed on Jan. 15, 2003.

(30) Foreign Application Priority Data
Jan. 31, 2002 (DE) 102 03 967.4

(51) Int. Cl. B67D 5/62; B22D 11/00; F25D 11/00; F25D 3/08

(52) U.S. Cl. 164/418; 62/457.2; 62/430

(57) ABSTRACT

A chill tube (1) having a double T-shaped inner and outer cross section in beam blank format is encased in a water-guiding jacket (12) adapted to its outer contour while forming a water gap (14). The wall thickness (D) of chill tube (1) in the rounded transition regions (2) from middle crosspieces (4), which face each other head to head and are drawn in towards longitudinal axis (3), to the neighboring crosswise positioned flanges (5) is dimensioned at least partially smaller than in the remaining wall sections (6, 7). The reduction in wall thickness is implemented by longitudinal hollow recesses (8). These recesses (8) extend only in the height range of the bath level. Into the cross sectional regions which are formed by the outer contour of chill tube (1) as well as the inner contour of water-guiding jacket (12), filler pieces (17) are incorporated, adapted to this cross section.

### BACKGROUND OF THE INVENTION

1. Field of the Invention

The invention relates to a mold/chill tube having a double T-shaped inner and outer cross section in beam blank format which is encased in a water-guiding jacket adapted to its outer contour while forming a water gap.

2. Description of Related Art

In the continuous casting of metals using a chill tube, the material temperatures in the chill wall result from the heat stresses occurring during continuous casting and the cooling conditions by the respective medium, which normally, in the form of water, flows from bottom to top in a water gap between a water-guiding jacket fitted to the outer contour of the chill tube and the outer surface of the chill tube, thereby taking up the heat encountered and carrying it off. The removal of the heat with the aid of the cooling water is largely determined by the speed of the water in the water gap.

In the continuous casting of metals using a chill tube of the type in question here, it has been observed that, because of the special geometry of the beam blank format, extreme local heat stresses occur in the transition regions from middle crosspieces, which face one another head to head and are drawn in in the direction towards the longitudinal axis, and the bordering flanges which are positioned at an angle. In the case of unfavorable geometrical relationships of the transition regions, these local heat stresses lead to overheating of the chill tube, and, as a result, to a drastic reduction in its service life.

### SUMMARY OF THE INVENTION

It is an object of the invention to develop a mold/chill tube having a double T-shaped inner and outer cross section in beam blank format for the continuous casting of metals, in which local overheating of the transitional regions is avoided, and thereby a longer service life is achieved.

These and other objects of the invention are achieved by a chill tube having a double T-shaped inner and outer cross section in beam blank format, which is encased in a water-guiding jacket (12) adapted to its outer contour while forming a water gap (14), wherein the wall thickness (D) of chill tube (1) in the rounded transition regions (2, 2a, 2b, 2c, 2d) from middle crosspieces (4), which face each other head to head and are drawn in towards longitudinal axis (3), to the neighboring crosswise positioned flanges (5) is dimensioned at least partially smaller than in the remaining wall sections (6, 7).

### BRIEF DESCRIPTION OF THE DRAWINGS

The invention will be described in greater detail with reference to the following drawings wherein:

FIG. 1 shows in schematic perspective, a chill tube in beam blank format without a water-guiding jacket having lateral filler pieces.

FIG. 2 shows likewise in schematic perspective, the chill tube of FIG. 1 along with a separately shown filler piece.

FIG. 3 shows a top view of a chill tube without cover plate in the region of the lateral channels, but having a water-guiding jacket.

FIG. 4 shows a top view onto a chill tube according to further specific embodiments without cover plate and water-guiding jacket.

### DETAILED DESCRIPTION OF THE INVENTION

On account of the at least partial reduction of the wall thickness of the chill tube in the rounded transition regions, a clearly improved heat removal is achieved, so that a local overheating of the transition regions is avoided, and as a result, the service life of the chill tube is clearly increased.

With respect to the fact that, in the continuous casting of metals, the highest heat stress in the chill tube occurs, as a rule, at the height range of the bath level, it is provided that the wall thickness in the transition regions is reduced only at the height range of the bath level.

The reduction of the wall thickness of the chill tube in the rounded transition regions can be carried out in various ways.

One option is that at the outside of the transition regions longitudinal hollow recesses are provided. The curvature of the recesses, in this case, may be largely adapted to the curvature of the inner surface of the transition regions. In addition, the reduction in wall thickness, in the form of a hollow recess, has the advantage that the outer surface of the chill tube is enlarged, so that an even better cooling effect may be achieved.

Another possibility of wall thickness reduction is that on the outside of the transition regions, a plurality of longitudinal grooves running side by side are provided. The cross section and/or depth of the grooves may be dimensioned to be equal or different in each transition region. The cross section of the grooves may be rounded or angular, such as triangular.

Furthermore, for the reduction in wall thickness in the wall sections of the transition regions, it is also possible to provide a plurality of longitudinal bores running next to one another. The size of the bores, their number, their distance apart, and also their position in relation to the outside or the inside contour of the chill tube may vary. However, it is advantageous if the bores are closer to the outer surface than to the inner surface of the chill tube.

Since heat removal using cooling water is determined, as is known, by the speed of the water in the water gap between the chill tube and the water-guiding jacket, this water gap should be maintained even in the region of the wall thickness reduction, in order to guarantee uniform water speed in the entire water gap. This being the case, in a specific embodiment, it is provided that the water-guiding jacket has a rectangular cross section, and, between the water-guiding jacket as well as the crosspieces and the flanges, filler pieces adjusted to the cross sectional region by the outer contour of the chill tube as well as the inner contour of the water-guiding jacket are incorporated.

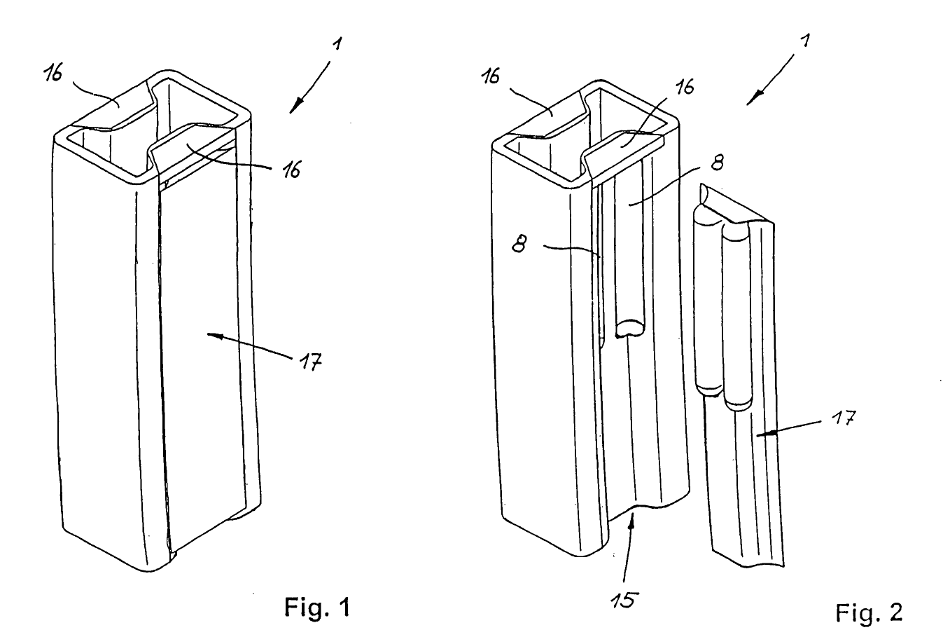

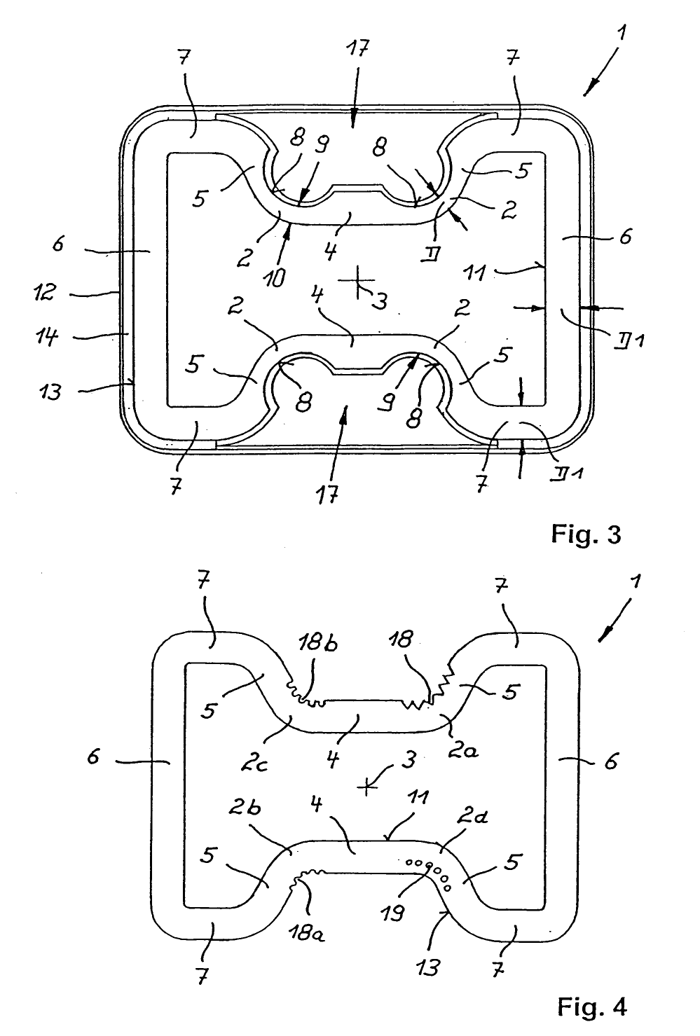

The numeral 1 in FIGS. 1 through 4 denotes a chill tube having a double T-shaped inner and outer cross section in beam blank format. Chill tube 1 is used for the continuous casting of metals. In FIGS. 3 and 4, the curvature of chill tube 1 in the longitudinal direction is not shown.

As may be seen in greater detail in FIG. 3, wall thickness D of chill tube 1 in rounded transition regions 2 from middle crosspieces 4, which face each other head to head and are drawn in towards longitudinal axis 3, to the neighboring, crosswise positioned flanges 5 is dimensioned less than wall thickness D1 in the remainder of wall sections 6 and 7.

The reduction in wall thickness takes place in the specific embodiment of FIGS. 1 through 3 in that, on the outside of transition regions 2, longitudinal hollow recesses 8 are provided. These recesses 8 extend, as may be seen in FIG. 2, only as far as the height range of the bath level which is not shown in detail. Curvature 9 of recesses 8 is largely adjusted to curvature 10 of inner surface 11 of chill tube 1 in transition ranges 2.

On the peripheral side of chill tube 1 there is a water-guiding jacket 12 which may be seen only in FIG. 3, having an essentially rectangular cross section. Between water-guiding jacket 12 and outer surface 13 of chill tube 1, a water gap 14 is formed through which cooling water is guided from bottom to top at a predefined water speed.

In order to achieve uniform water speed in water gap 14, even in lateral channels 15 of chill tube 1, which, according to FIGS. 1 and 2 are closed off at their upper end by cover plate 16 in water gap 14, these channels are provided with filler pieces 17, which, in the upper region are also adapted to hollow recesses 8.

FIG. 4 shows four different specific embodiments of how the reduction in wall thickness of chill tube 1 may also be implemented.

In transition regions 2a, 2b, 2c, on the outer side, several longitudinal grooves 18, 18a, 18b are provided which run next to one another. Whereas in transition region 2a grooves 18 have a triangular cross section, grooves 18a, 18b in transition regions 2b, 2c have rounded bottoms. In this context, grooves 18b in transition region 2c have a greater depth than grooves 18a in transition region 2b.

In transition region 2d, reduction in wall thickness is implemented by bores 19. These bores 19 lie closer to outer surface 13 of chill tube 1 than to inner surface 11.

Both grooves 18, 18a, 18b and bores 19 extend, as do recesses 8, only in the height range of the bath level.

1-16. (Canceled).

17. A mold for the continuous casting of molten material comprising:
an elongated hollow member defining a casting passage which extends longitudinally of said hollow member, said casting passage having an inlet end for the molten material and an outlet end for a continuously cast product formed from the molten material, and said casting passage including a first portion and a second portion, said second portion of said casting passage varying in at least one dimension and having at least one location where said one dimension is smaller than at any location of said first portion of said casting passage, and said hollow member comprising a wall which includes a first section partially bounding said first portion of said casting passage and a second section partially bounding said second portion of said casting passage, said second section of said wall having at least one segment with a wall thickness which is less than that at any location of said first section of said wall.

18. The mold of claim 17, wherein said second portion of said casting passage has at least one part at which said one dimension is a minimum, said one segment of said wall adjoining said one part.

19. The mold of claim 18, wherein said second section of said wall has another segment which extends from said one segment of said wall along said one part of said casting passage, said other segment widening in a direction away from said one segment.

20. The mold of claim 17, wherein said wall includes an additional section which partially bounds said second portion of said casting passage, said second portion being sandwiched between said second section and said additional section of said wall, and said additional section having an additional segment with a wall thickness which is less than that at any location of said first section of said wall.

21. The mold of claim 20, wherein said casting passage has another portion and said second portion of said casting passage is located between said first portion and said other portion of said casting passage, said one dimension at said one location being smaller than at any location of said other portion, and said wall including another section which partially bounds said other portion of said casting passage, the wall thickness of said one segment being less than that at any location of said other section, and said second section and said additional section of said wall each bridging said first section and said other section of said wall.

22. The mold of claim 17, wherein said second portion of said casting passage has at least one part which narrows in a direction away from said first portion of said casting passage.

23. The mold of claim 22, wherein said second portion of said casting passage has an additional part which narrows in a direction towards said first portion of said casting passage.

24. The mold of claim 23, wherein said casting passage has another portion and said second portion of said casting passage is located between said first portion and said other portion of said casting passage, said one dimension at said one location being smaller than at any location of said other portion, and said wall including another section which partially bounds said other portion of said casting passage, the wall thickness of said one segment being less than that at any location of said other section of said wall, and said second portion of said casting passage having at least one part at which said one dimension is a minimum, said one part being substantially centered with respect to said first portion and said other portion of said casting passage.

25. The mold of claim 24, wherein said casting passage resembles a beam having a pair of flanges joined by a web.

26. The mold of claim 17, wherein said second section of said wall has at least one additional segment between said first section of said wall and said one segment of said wall, said additional segment narrowing in a direction away from said first section of said wall.

27. The mold of claim 26, wherein said second portion of said casting passage has at least one part at which said one dimension is a minimum and said one additional segment of said wall is located to one side of said one part, said second section of said wall having a second additional segment which is located to an opposite side of said one part and narrows in a direction towards said first section of said wall.

28. The mold of claim 17, wherein said first section of said wall has a substantially constant wall thickness.

29. The mold of claim 17, wherein said second section of said wall defines at least one concavity as seen from externally of said hollow member.

30. The mold of claim 17, wherein said first section of said wall has at least one location with a predetermined wall thickness less than or equal to the wall thickness at all other locations of said first section, said one segment being concave as seen from externally of said hollow member and including a first surface portion which faces said casting passage and has a first radius, and said one segment further including a second surface portion which faces away from said casting passage and has a second radius smaller than said first radius, the difference between said first radius and said second radius being less than said predetermined wall thickness.
